(19) United States
(12) Patent Application Publication
(10) Pub. No.: US 2017/0021249 A1
(43) Pub. Date: Jan. 26, 2017

(54) BALL BAT INCLUDING MULTIPLE ALLOYS

(71) Applicant: EASTON BASEBALL/SOFTBALL INC., VAN NUYS, CA (US)

(72) Inventors: Linda Hunt, Simi Valley, CA (US); Grant Douglas, Santa Monica, CA (US); Ian Montgomery, Simi Valley, CA (US)

(21) Appl. No.: 14/804,152

(22) Filed: Jul. 20, 2015

(51) Int. Cl. A63B 59/51; B23K 20/22; B23K 20/12

(52) U.S. Cl. CPC A63B 59/51; B23K 20/122; B23K 20/12; B23K 20/129; B23K 20/22; B23K 2203/10

(57) ABSTRACT

A ball bat includes a barrel section welded, adhered, or mechanically affixed to a handle section at a joint positioned in a taper region of the bat. The joint may alternatively be positioned in other regions, such as in the barrel region or the handle region. The barrel section may include a different metal alloy than the handle section. For example, the barrel section may include 6061 aluminum alloy and the handle section may include 7050 aluminum alloy. In some embodiments, the welded joint may be formed from a spin-welding process. The bat provides a strong handle in combination with a barrel that meets BBCOR or other performance requirements.

### BACKGROUND

Baseball and softball governing bodies have imposed various bat performance limits over the years with the goal of regulating batted ball speeds. Each association generally independently develops various standards and methods to achieve a desired level of play. Bat designers typically comply with these performance standards by adjusting the performance, or bat-ball coefficient of restitution (“BBCOR”), of their bat barrels. One method of controlling BBCOR includes thickening the barrel wall of a hollow metal bat. But certain metals have shortcomings when implemented in a baseball bat, such as heavy weight or limited strength. And barrel walls in metal bats undergo different stresses than the handles of those bats, so a material that is suitable for a barrel may not be suitable for the handle.

In addition, thickening a barrel wall generally increases the bat's weight and, more importantly, its “swing weight” or moment of inertia (“MOI”). MOI is the product of: (a) a mass, and (b) the square of the distance between the center of the mass and the point from which the mass is pivoted. Mathematically, this is expressed as follows:

MOI=ΣMass×(Distance)²

Accordingly, the MOI dictates that it becomes increasingly difficult to swing a bat as the bat's mass increases or as the center of the bat's mass moves farther from the pivot point of the swing (i.e., farther from the batter's hands). Because thickening the barrel wall increases the bat's weight at a region relatively distal from the batter's hands, doing so also increases the bat's MOI. Thus, while thickening a barrel wall may effectively stiffen the barrel and reduce its performance, the consequent increase in MOI is generally undesirable for batters.

### SUMMARY

A ball bat includes a barrel section welded or adhered to a handle section at a joint positioned in a taper region between a barrel region and a handle region of the bat. In some embodiments, the joint may be positioned in other regions, such as the barrel region or the handle region. The joint may include an overlapping interface between the handle section and the barrel section, or the barrel section may generally abut the handle section in an edge-to-edge or butt joint. The barrel section may include a different metal alloy than the handle section. For example, the barrel section may include 6061 aluminum alloy and the handle section may include 7050 aluminum alloy. In some embodiments, the joint may be formed by a spin-welding process. In yet other embodiments, the joint may be a mechanically interlocked joint in which a protrusion is engaged with a groove, or in which a divot or crimp engages with a corresponding bead or crimp. The bat provides a strong handle in combination with a barrel that meets BBCOR or other performance requirements.

Other features and advantages will appear hereinafter. The features described above may be used separately or together, or in various combinations of one or more of them.

### BRIEF DESCRIPTION OF THE DRAWINGS

In the drawings, wherein the same reference number indicates the same element throughout the views:

FIG. 1 is a perspective view of a ball bat in accordance with an embodiment of the present technology.

FIG. 2 is a cross-sectional view of an overlapping joint in a ball bat in accordance with an embodiment of the present technology.

FIG. 3 is a partial cross-sectional view of a ball bat in a welding fixture in accordance with an embodiment of the present technology.

FIG. 4 is a partial cross-sectional view of an edge-to-edge interface or butt joint in a ball bat in accordance with an embodiment of the present technology.

FIG. 5 is a perspective view of a ball bat including an overlapping joint in the handle region of the ball bat in accordance with an embodiment of the present technology.

FIG. 6 is a perspective view of a ball bat including an overlapping joint in the barrel region of the ball bat in accordance with an embodiment of the present technology.

FIG. 7 is a cross-sectional view of a mechanically interlocked, overlapping groove joint in a ball bat in accordance with an embodiment of the present technology.

FIG. 8 is a cross-sectional view of another mechanically interlocked, overlapping groove joint in a ball bat in accordance with another embodiment of the present technology.

FIG. 9 is a cross-sectional view of a mechanically interlocked, overlapping crimp joint in a ball bat in accordance with an embodiment of the present technology.

### DETAILED DESCRIPTION

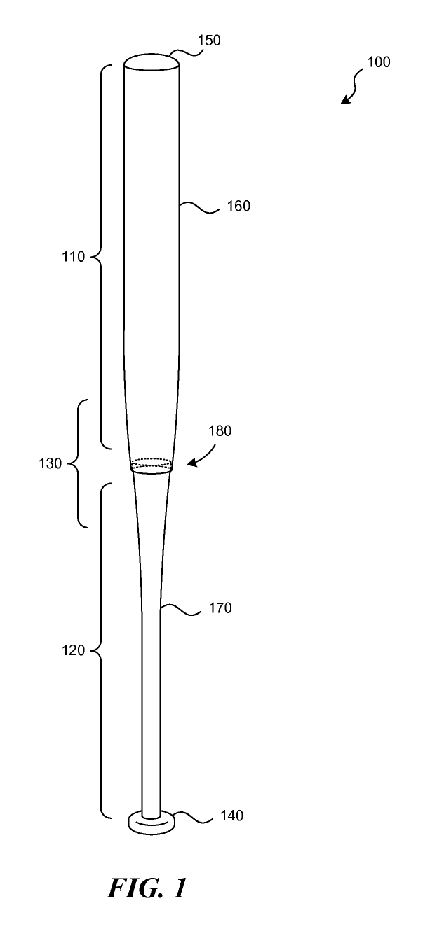

The present technology is directed to ball bats including multiple alloys, and methods for joining multiple alloys of a ball bat. Various embodiments of the technology will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments. Accordingly, the technology may have other embodiments with additional elements or without several of the elements described below with reference to FIGS. 1-9.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to baseball or softball. The technology may also be used in other sporting good implements.

The present technology provides a multiple-piece bat with favorable weight characteristics similar to a single-piece bat, while also providing a barrel that meets BBCOR or other standards and a handle of suitable strength. Examples of this technology are illustrated in FIGS. 1-9.

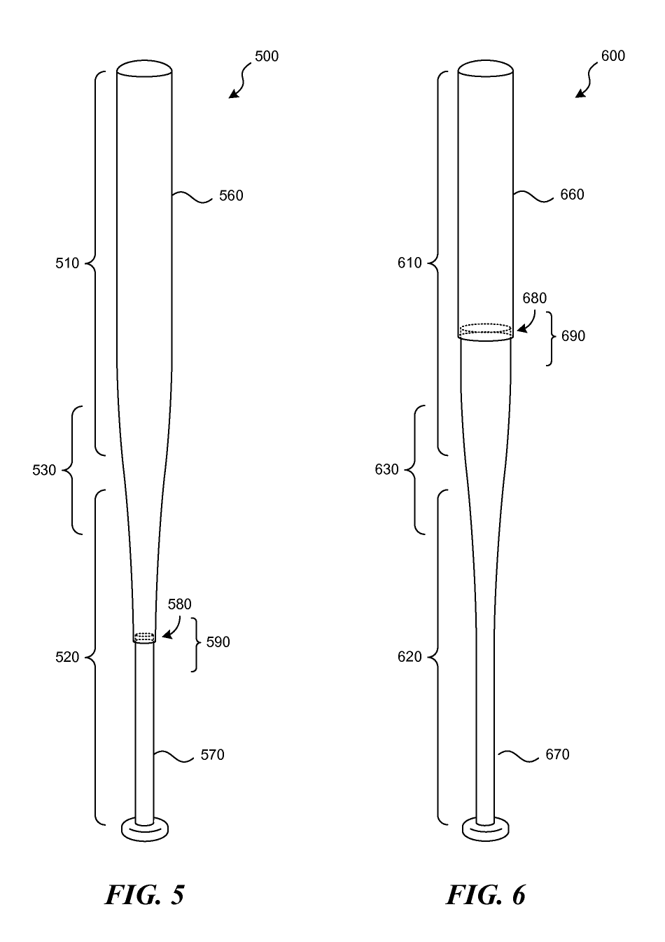

Turning now to the drawings, FIG. 1 illustrates a ball bat 100 having a barrel region 110 and a handle region 120. There may be a transitional or taper region 130 in which the larger diameter of the barrel region 110 transitions to the narrower diameter of the handle region 120. The handle region 120 may include an end knob 140 and the barrel region 110 may be closed with an end cap 150. In FIG. 1, the bat 100 is formed from two sections including a first section or barrel section 160 and a second section or handle section 170. FIG. 1 shows the barrel section 160 as generally coextensive with the barrel region 110, while the handle section 170 is depicted as generally coextensive with the handle region 120. In other embodiments, the sections need not be coextensive with the regions and other suitable configurations are contemplated (for example, as described in further detail below for FIGS. 5 and 6).

The barrel section 160 and the handle section 170 may be joined at a joint 180. In some embodiments, the joint 180 may be located in the taper region 130 as shown in FIG. 1. In other embodiments, the joint 180 may be located in other regions (for example, as described in further detail below for FIGS. 5 and 6).

The bat 100 may have any suitable dimensions. The bat 100 may have an overall length of 20 to 40 inches, or 26 to 34 inches. The overall barrel diameter may be 2.0 to 3.0 inches, or 2.25 to 2.75 inches. Typical ball bats have diameters of 2.25, 2.625, or 2.75 inches. Bats having various combinations of these overall lengths and barrel diameters, or any other suitable dimensions, are contemplated herein. The specific preferred combination of bat dimensions is generally dictated by the user of the bat 100, and may vary greatly between users.

The joint 180 may be positioned in a variety of locations, depending on the design goals for a given bat. For example, in a bat 100 that is approximately 31.5 inches long, with or without an end cap 150 or a knob 140, a joint 180 may be positioned approximately 19 inches from an end of the handle section 170. In some embodiments, the barrel section 160 or the handle section 170 may have thicknesses of approximately 0.04 inches to 0.20 inches. In yet other embodiments, other suitable dimensions may be used.

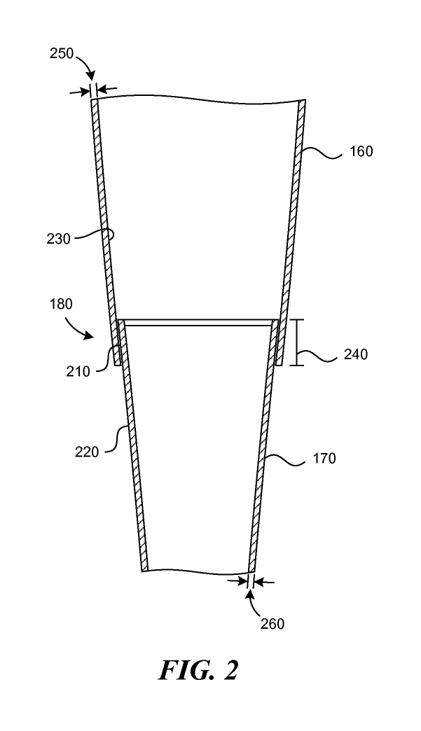

Turning now to FIG. 2, the barrel section 160 and the handle section 170 may be tightly fitted to each other via an overlapping concentric interface 210. In an overlapping interface 210, an outer surface 220 of the handle section 170 may be pressed against an inner surface 230 of the barrel section 160. The outer surface 220 of the handle section 170 has a diameter that is slightly smaller than the diameter of the inner surface 230 of the barrel section 160 to maintain a tight fit. In some embodiments, the shape of the taper region 130 (shown in FIG. 1) and the joint 180 allows the handle section 170 to maintain a tight or interference fit with the barrel section 160. For assembly, the handle section 170 may be passed inside and partially through the barrel section 160 (from the region of the end cap 150 shown in FIG. 1) such that the handle section 170 and the barrel section 160 contact each other at the interface 210. In some embodiments, the overlap distance 240 may be approximately 0.06 to 1.50 inches, while in other embodiments, other suitable dimensions may be used.

During performance testing of ball-bat designs to determine compliance with new BBCOR standards for youth baseball, the applicants were surprised to discover that using 6061 aluminum alloy in a ball bat provided a larger reduction in performance (BBCOR) than expected. The applicants discovered that a bat made of 6061 aluminum alloy would meet performance standards even without including a stiffener in the barrel or thickening the barrel wall.

But 6061 aluminum alloy is not as strong or durable as many other alloys, such as 7050 aluminum alloy, for example, so 6061 aluminum alloy could typically be used only in bats designed for entry-level players who are not as strong as more advanced players. A handle made of 6061 aluminum alloy, for example, may not be able to withstand the stresses imparted by a stronger player.

In some embodiments of the present technology, the favorable characteristics of the 6061 aluminum alloy in the barrel section 160 may be combined with a stronger alloy in the handle section 170, such as 7050 aluminum alloy. Other suitable alloys may be used. For example, for a more affordable bat, 7046 aluminum alloy may be used in the handle section 170 when material strength is not as important, such as when the bat is designed for lower-strength players.

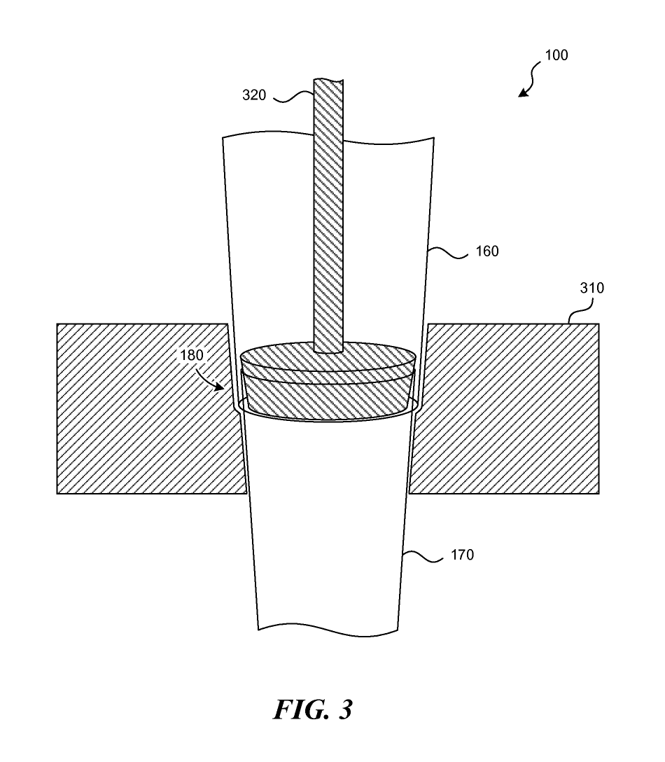

Turning now to FIG. 3, in some embodiments, the handle section 170 and the barrel section 160 may be joined using a spin-welding or friction-stir-welding process. In those processes, friction created at the interface between two metals generates heat that melts the metals such that they mix together and cool into a combined union. A fixture 310 contoured to the region where the joint 180 is located (for example, the taper region 130) may support the barrel section 160 and the handle section 170 during the welding process. The fixture 310 holds the outer contour of the assembled bat 100 while a mandrel 320 suitably shaped for the interior of the bat 100 may be pressed inside the bat 100 near the joint 180 to keep the sections 160 and 170 of the bat 100 concentric and centered during the welding process. The mandrel 320 also prevents the bat 100 from collapsing inwardly during welding. In some embodiments, at least one of the barrel section 160 and the handle section 170 is spun with respect to the other section 160, 170. Spinning creates friction at the joint 180 to heat and weld the materials together. Care must be taken during the welding process to avoid low-quality welds—or making the heat-affected area too large—so as not to produce a weak bat 100.

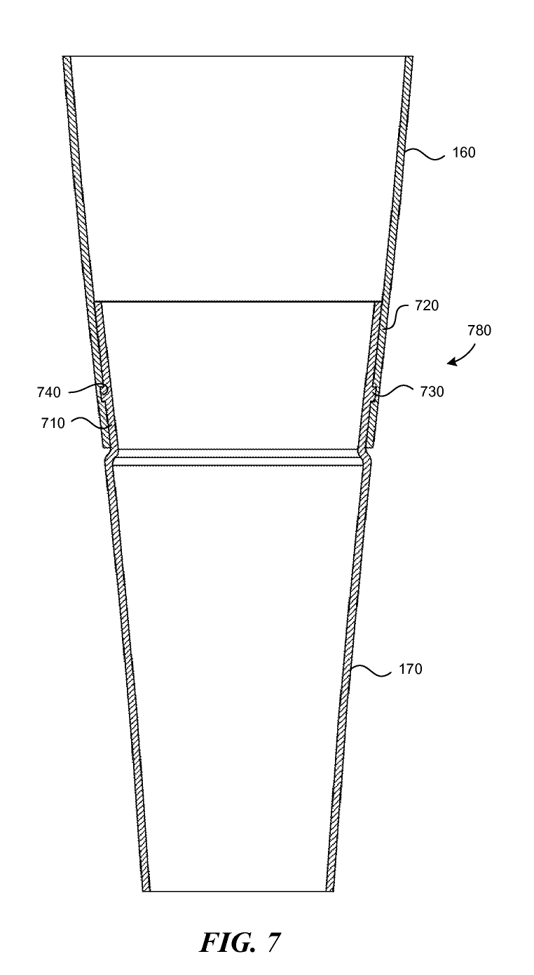

In alternative embodiments, the handle section 170 and the barrel section 160 may be affixed to each other with an adhesive, such as cyanoacrylate glue, or they may be joined using welding processes. In other embodiments, the handle section 170 and the barrel section 160 may be affixed together with one or more rivets, snaps, pins, or other suitable mechanical attachments. And, as described in further detail below for FIGS. 7, 8, and 9, the handle section 170 and the barrel section 160 may be affixed together using a mechanically interlocking joint, such as an overlapping groove or crimp joint. In yet other embodiments, it may be desirable to join the alloy sections during the formation of the bat blank rather than afterwards. The joint 180 may be made smooth for aesthetic and other reasons.

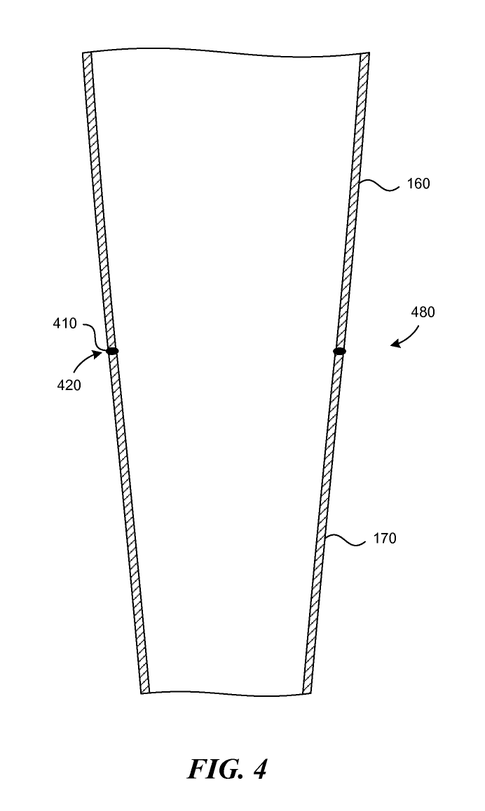

FIG. 4 illustrates an alternative joint 480 used to join a barrel section 160 and a handle section 170. Joint 480 may include an edge-to-edge interface or butt joint 410 that may include a weld region 420. The barrel section 160 and the handle section 170 may abut each other and may be welded together with a spin-welding or friction-stir-welding process, as described above. Alternatively, the barrel and handle sections 160, 170 may be mechanically affixed to each other with fasteners or adhesive, as described above. In some embodiments, the edge-to-edge interface or butt joint 410 may occur between angled or flat surfaces, or between other suitable surfaces of the respective barrel and handle sections 160, 170.

In some embodiments, as shown in FIGS. 5 and 6, for example, a joint between bat sections may be located in other regions of the bat. FIG. 5 illustrates a bat 500 having a barrel region 510, a handle region 520, and a taper region 530 between the barrel region 510 and the handle region 520. The joint 580 between the first section or barrel section 560 and the second section or handle section 570 may be located in a generally straight region 590 of the handle region 520.

FIG. 6 illustrates a bat 600 having a barrel region 610, a handle region 620, and a taper region 630 between the barrel region 610 and the handle region 620. The joint 680 between the first section or barrel section 660 and the second section or handle section 670 may be located in a generally straight region 690 of the barrel region 610. The joints 580 and 680 may be constructed in a similar fashion as the joints 180 and 480 described above, for example.

Any of the joints described herein may be located in various regions of a bat, but performance characteristics will vary depending on the location of the joint. For example, if a joint is located in a barrel region (e.g., as shown in FIG. 6), performance (e.g., BBCOR) may exceed regulation, while a joint in a handle region (e.g., as shown in FIG. 5) may cause decreased strength in the handle.

FIGS. 7, 8, and 9 illustrate additional alternative embodiments of joints connecting a barrel section 160 and a handle section 170. FIG. 7 illustrates a mechanically interlocked, overlapping groove joint 780. In the groove joint 780, the handle section 170 may have an end portion or extension portion 710 that fits generally concentrically into a receiving portion 720 of the barrel section 160. The extension portion 710 may have a peripheral protrusion 730 around all or part of the extension portion 710 that mates with a corresponding peripheral groove 740 in the barrel section 160. The extension portion 710 may also have a tapered shape that generally conforms to the shape of the region around the joint 780. In assembly, the handle section 170 and the barrel section 160 may be pulled in opposing directions until the protrusion 730 snaps into the groove 740. In this way, the barrel section 160 and the handle section 170 are mechanically interlocked together at the joint 780. In other embodiments (not shown), the protrusion 730 can be located on the receiving portion 720, with the groove 740 being located in the extension portion 710.

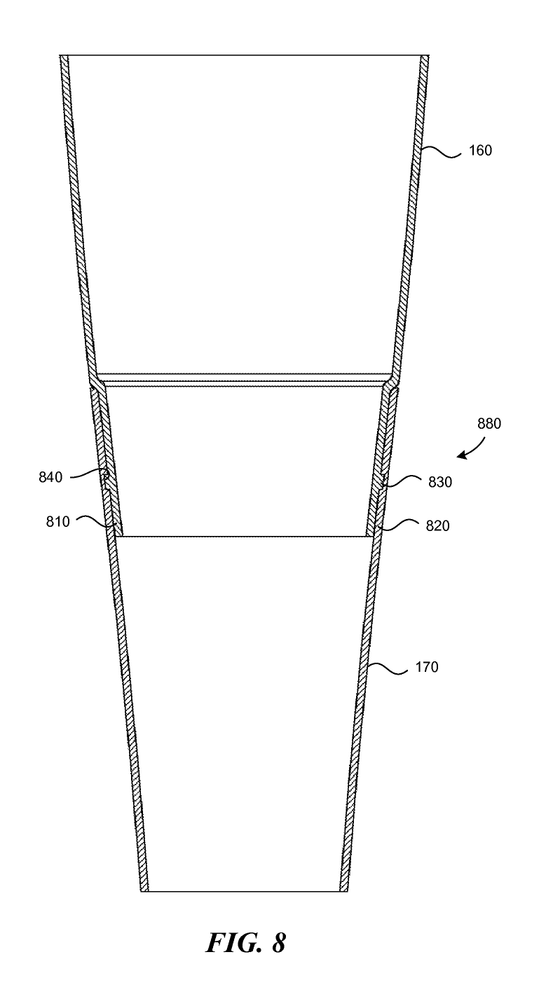

Similarly, FIG. 8 illustrates another embodiment of a mechanically interlocked, overlapping groove joint 880. In the groove joint 880, the barrel section 160 may have an end portion or extension portion 810 that fits generally concentrically into a receiving portion 820 of the handle section 170. The extension portion 810 may have a peripheral protrusion 830 around all or part of the extension portion 810 that mates with a corresponding peripheral groove 840 in the receiving portion 820 of the handle section 170. The extension portion 810 may also have a tapered shape that generally conforms to the shape of the region around the joint 880. In assembly, the handle section 170 and the barrel section 160 may be pushed toward each other until the protrusion 830 snaps into the groove 840. In this way, the barrel section 160 and the handle section 170 are mechanically interlocked together at the joint 880. In other embodiments (not shown), the protrusion 830 can be located on the receiving portion 820, with the groove 840 being located in the extension portion 810.

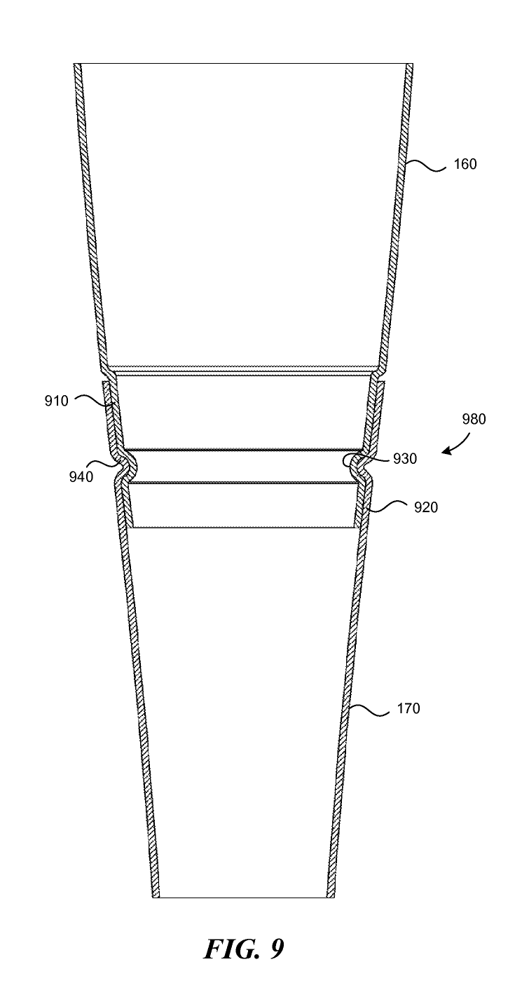

FIG. 9 illustrates a mechanically interlocked, overlapping crimp joint 980. In the crimp joint 980, the barrel section 160 may have an end portion or extension portion 910 that fits generally concentrically into a receiving portion 920 of the handle section 170. The extension portion 910 may have a rounded divot or crimp 930 circumferentially around all or part of the extension portion 910 that mates with a corresponding rounded bead or crimp 940 in the receiving portion 920 of the handle section 170. The extension portion 910 may have a tapered shape that generally conforms to the shape of the region around the joint 980. In assembly, the handle section 170 and the barrel section 160 may be pushed toward each other until the rounded bead or crimp 940 mates with the corresponding rounded divot or crimp 930. In this way, the barrel section 160 and the handle section 170 are mechanically interlocked together at the joint 980. In other embodiments, a mechanically interlocked overlapping crimp joint may be formed with an extension portion of the handle section 170 mating with a receiving portion of the barrel section 160 (similar to FIG. 7 in that the barrel section 160 would overlap the handle section 170) via a crimp joint similar to that shown in FIG. 9, such that a divot or crimp of the handle section mates with a bead or crimp of the barrel section. The beads, divots, and crimps may have any suitable size or shape, and in some embodiments, they may be oriented to face inwardly or outwardly relative to a central portion of the bat 100.

The mechanically interlocking joints described above and illustrated in FIGS. 7-9 may provide increased joint strength, even in the absence of welding. These joints may be used in conjunction with welding, as well. The mating interlocking features in the joints 780, 880, and 980 may be formed from machining or crimping, or they may be formed in another suitable manner, such as hydroforming.

The joints described herein accommodate the connection between two different alloys. These joints further enable the manufacturing of a ball bat from two or more sections that approximates a single-piece design in terms of weight, while taking advantage of the properties of different alloys chosen for the various sections, such as favorable BBCOR characteristics in the barrel region combined with favorable strength and durability in the handle region.

From the foregoing, it will be appreciated that specific embodiments of the disclosed technology have been described for purposes of illustration, but that various modifications may be made without deviating from the technology, and elements of certain embodiments may be interchanged with those of other embodiments. For example, in some embodiments, an end cap (e.g., 150) may or may not be integral with a barrel section (e.g., 160). And in some embodiments, a barrel section may be positioned at least partially concentrically within a handle section such that the handle section overlaps the barrel section. In other embodiments, different welding or attachment techniques may be used, or other dimensions may be used depending on the desired BBCOR value or cost. In yet other embodiments, bats may be made from three or more alloy sections.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein, and the invention is not limited except as by the appended claims.

What is claimed is:

1. A ball bat comprising:
a barrel section comprising a first metal alloy; and
a handle section joined to the barrel section at a joint, the handle section comprising a second metal alloy that is stronger than the first metal alloy.

2. The ball bat of claim 1 wherein the barrel section has a first diameter and the handle section has a second diameter smaller than the first diameter.

3. The ball bat of claim 1 wherein the joint comprises an overlapping interface in which at least a portion of the handle section is positioned within the barrel section.

4. The ball bat of claim 1 wherein the joint comprises an overlapping interface in which at least a portion of the barrel section is positioned within the handle section.

5. The ball bat of claim 1 wherein the barrel section generally abuts the handle section at the joint.

6. The ball bat of claim 1 wherein the first metal alloy comprises 6061 aluminum alloy and the second metal alloy comprises 7050 aluminum alloy.

7. The ball bat of claim 1 wherein the barrel section is welded to the handle section at the joint.

8. A ball bat comprising:
a first bat section comprising a first metal alloy;
a second bat section attached to the first bat section at a joint, the second bat section comprising a second metal alloy that is stronger than the first metal alloy;
wherein the first bat section forms at least a part of a barrel region and the second bat section forms at least a part of a handle region.

9. The ball bat of claim 8 wherein the first bat section is welded to the second bat section at the joint.

10. The ball bat of claim 9 wherein the welded joint is formed from a spin-welding process.

11. The ball bat of claim 8 wherein the first bat section is adhered to the second bat section at the joint.

12. The ball bat of claim 8 wherein:
the barrel region has a first diameter;
the handle region has a second diameter smaller than the first diameter; and
the joint is positioned in a taper region between the barrel region and the handle region.

13. The ball bat of claim 8 wherein the joint is positioned in a generally straight region of the barrel region.

14. The ball bat of claim 8 wherein the joint is positioned in a generally straight region of the handle region.

15. The ball bat of claim 8 wherein the first metal alloy comprises 6061 aluminum alloy and the second metal alloy comprises 7050 aluminum alloy.

16. The ball bat of claim 8 wherein the first bat section overlaps the second bat section at the joint.

17. The ball bat of claim 8 wherein the second bat section overlaps the first bat section at the joint.

18. The ball bat of claim 8 wherein the first bat section abuts the second bat section at the joint.

19. A method of making a sporting good implement, the method comprising:
providing a first section comprising a first aluminum alloy;
providing a second section comprising a second aluminum alloy different from the first aluminum alloy;
sliding the second section through the first section to engage the first section with the second section;
welding the first section to the second section by spinning one of the first section or the second section with respect to the other section while the first section and the second section are in contact with each other.

20. The method of claim 19 further comprising:
supporting the engaged first and second sections in a fixture; and
inserting a mandrel into an interior region of the connected first and second sections, the mandrel configured to support the connected first and second sections during the welding process.
